(19) United States
(12) Patent Application Publication
(10) Pub. No.: US 2005/0071645 A1
(43) Pub. Date: Mar. 31, 2005

(54) Algorithmic generation of passwords

(75) Inventors: Janice Marie Girouard, Austin, TX (US); Dustin Kirkland, Austin, TX (US); Emily Jane Ratliff, Austin, TX (US); Kent Edward Yoder, Austin, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/671,058

(22) Filed: Sep. 25, 2003

(51) Int. Cl. H04K 1/00

(52) U.S. Cl. 713/183

(57) ABSTRACT

Exemplary embodiments of the present invention include a method for providing a password to an application. Such exemplary embodiments include receiving, from a user, a passkey event uniquely associated with one of a plurality of applications requiring a password, and receiving, from a user, a same master password for access to each of the plurality of applications, applying a hashing algorithm associated with the separate input event to the master password to generate an application specific password, and submitting the application specific password to the application for access by the user. In some embodiments, receiving, from a user, a passkey event uniquely associated with any given one of the plurality of applications includes receiving, from a user, an event created by a user's engaging a keyboard key.

### BACKGROUND OF THE INVENTION

1. Field of the Invention

The field of the invention is data processing, or, more specifically, methods, systems, and products for providing a password to an application.

2. Description of Related Art

Users of multiple password protected applications face the ongoing problem of having to remember different passwords for the various password protected applications that they access. Often the various password protected applications have different requirements for their passwords thereby increasing the number of different passwords a user must remember. Some administrators of password protected applications also require passwords to be periodically changed thereby increasing the frequency a user must learn a new password.

In response to requirements for different passwords for different applications, different password requirements, and periodically changing passwords, users often choose passwords are easy to remember and that meet the requirements of many password protected applications or record the passwords and store them in an unprotected location. Passwords that are easy to remember are often considered weak passwords. That is, they are passwords that are not difficult for an intruder to crack. Some users who do not choose weak passwords, still leave their passwords unprotected by recording the passwords and storing them in an unprotected location, such as physically storing the passwords on a pad of paper next to their computer or electronically storing the passwords on the computer itself in an unprotected file.

Conventional password administering programs exist that allow a user to provide a single password to access multiple password protected applications. Such password administering programs typically store various application specific passwords for different password protected applications in a database. Once a user provides a single password to access the password administering application, the password administering program can retrieve and submit the appropriate application specific password for the user to the password protected application. Such convention password administering programs require maintaining a database of passwords for the user, and must be updated each time a new application requiring a password is added to the system.

Other conventional programs for administering various passwords maintain a list of the user's passwords in plain text and then encrypt the file under a global password. Users decrypt the list of passwords with the global password, and then copy and paste the appropriate password to submit the password to the application. Such applications are only as secure as the global password used to access the list of passwords. Such convention programs are therefore only marginally more secure than the individual passwords encrypted in the list.

There is a need for a method, system, and computer product for providing a password to an application that is secure, does not require compliance with the particular application being accessed, and is not burdensome to the user.

### SUMMARY OF THE INVENTION

Exemplary embodiments of the present invention include a method for providing a password to an application. Such embodiments typically include receiving, from a user, a passkey event uniquely associated with one of a plurality of applications requiring a password, receiving, from a user, a same master password for access to each of the plurality of applications, applying a hashing algorithm associated with the separate input event to the master password to generate an application specific password, and submitting the application specific password to the application for access by the user. In some embodiments, receiving, from a user, a passkey event uniquely associated with any given one of the plurality of applications includes receiving, from a user, an event created by a user's engaging a keyboard key.

In typical embodiments of the present invention, applying a hashing algorithm associated with the passkey event to the same master password to generate an application specific password includes retrieving a hash value associated with the passkey event, and applying the hash value to at least one character of the same master password to generate at least one hashed character. In many embodiments of the present invention, retrieving a hash value associated with the passkey event includes retrieving hash value from a user's configuration file. In some embodiments, retrieving a hash value associated with the passkey event includes retrieving a hash value from a configuration register.

In many embodiments of the present invention, applying a hashing algorithm associated with the passkey event to the master password to generate an application specific password includes retrieving a character rule algorithm, and applying the character rule algorithm to the hashed character to generate a character rule compliant hashed character. In some embodiments, applying a hashing algorithm associated with the passkey event to the master password to generate an application specific password includes retrieving a master rule algorithm, and applying the master rule algorithm.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of automated computing machinery useful in providing an algorithmically generated password to an application.

FIG. 2 is a software architecture diagram illustrating an exemplary method for providing a password to an application in accordance with the present invention.

FIG. 3 is a software architecture diagram illustrating an exemplary method of applying a hashing algorithm associated with the passkey event to a master password to generate an application specific password in accordance with the present invention.

FIG. 4 is a flow chart illustrating an exemplary method for providing a password to an application in accordance with the present invention.

### DETAILED DESCRIPTION OF EXEMPLARY EMBODIMENTS

### Introduction

The present invention is described to a large extent in this specification in terms of methods for providing a password to an application. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Algorithmic Generation of Passwords

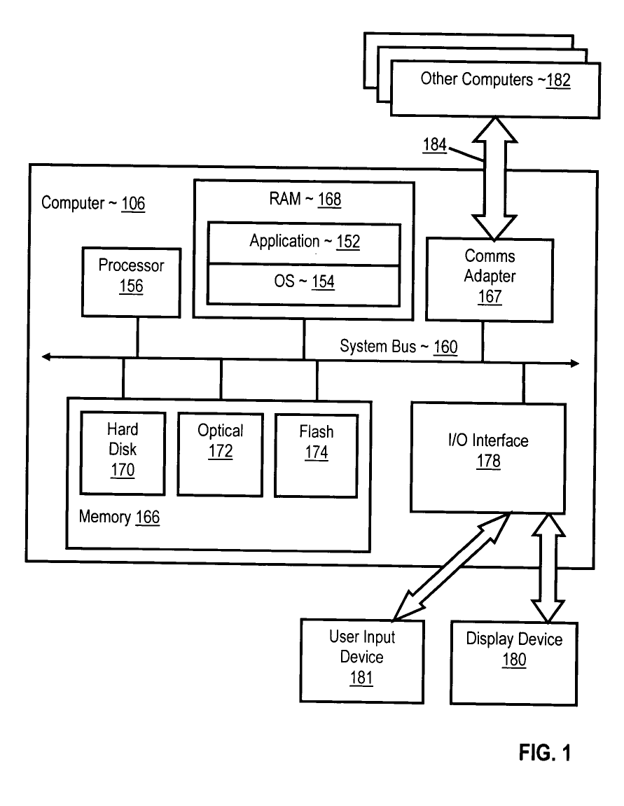

Methods, systems, and products for providing a password to an application according to exemplary embodiments of the present invention are explained with reference to the accompanying drawings, beginning with FIG. 1. FIG. 1 sets forth a block diagram of automated computing machinery useful in providing a password to an application in accordance with various embodiments of the present invention. The automated computing machinery of FIG. 1 includes a computer 106, such as a personal computer, laptop, minicomputer, mainframe, or any other computer that will occur to those of skill in the art. In fact, as the term is used in this specification, “computer” refers to automated computing machinery generally. The term “computer” therefore includes not only general purpose computers such as laptops, personal computer, minicomputers, and mainframes, but also includes devices such as personal digital assistants (“PDAs), network enabled handheld devices, internet-enabled mobile telephones, and so on.

The computer 106 of FIG. 1 includes at least one computer processor 156 or ‘CPU’ coupled through a system bus 160 to non-volatile computer memory 166 and to other components of the computer. Non-volatile computer memory 166 may be implemented as a hard disk drive 170, optical disk drive 172, electrically erasable programmable read-only memory space (so-called ‘EEPROM’ or ‘Flash’ memory) 174, or as any other kind of non-volatile computer memory as will occur to those of skill in the art.

The example computer 106 of FIG. 1 includes a communications adapter 167 that implements connections for data communications 184 to other computers 182, email servers and email clients. Communications adapters implement the hardware level of data communications connections through which client computers and servers send data communications directly to one another and through networks. Examples of communications adapters include modems for wired dial-up connections, Ethernet (IEEE 802.3) adapters for wired LAN connections, and 802.11b adapters for wireless LAN connections.

The example computer 106 of FIG. 1 includes one or more input/output interface adapters 178. Input/output interface adapters in computers implement user-oriented input/output through, for example, software drivers and computer hardware for controlling output to display devices 180 such as computer display screens, as well as user input from user input devices 181 such as keyboards and mice.

The example computer 106 of FIG. 1 also includes random access memory 168 (“RAM”). Stored in RAM 168 is an operating system 154 and a password protected application 152. The operating system 154 of FIG. 1 controls the allocation and usage of hardware resources such as memory, CPU time, user input devices and display devices. The operating system 154 includes system functions and input/output routines that administer input and output from interface adapters, user input devices, display devices, and the like. The operating system of FIG. 1 also includes a passkey function. The passkey function of the operating system algorithmically generates an application specific password and submits the application specific password to a password protected application 152 in accordance with the present invention. The operating systems input/output routines gather passkey events, input of master password characters, and deactivating events pertinent to operation of the passkey function and pass them to the passkey function.

The passkey function is activated when the operating system receives a passkey event created by a user's invoking an input device pre-designated as a passkey for the password protected application, such as by depressing a particular key on a keyboard. In typical embodiments, while the passkey function is active, a user inputs a master password that is the same for a plurality of password protected applications. The passkey function then retrieves an application specific hashing algorithm associated with that passkey event. When the passkey function is deactivated, by for example, a user releasing the passkey, the passkey function applies the retrieved hashing algorithm to the master password to generate an application specific password and submits the application specific password to the application. Conventional operating systems capable of modification to implement a passkey function in accordance with the present invention include Unix™, Linux™, Microsoft NT™, and others as will occur to those of skill in the art.

The passkey function is described in this specification as an extension or modification to an operating system for clarity of explanation not for limitation. The passkey function can, in other embodiments, be implemented not as an extension of the operating system, but as a separate application or program as will occur to those of skill in the art.

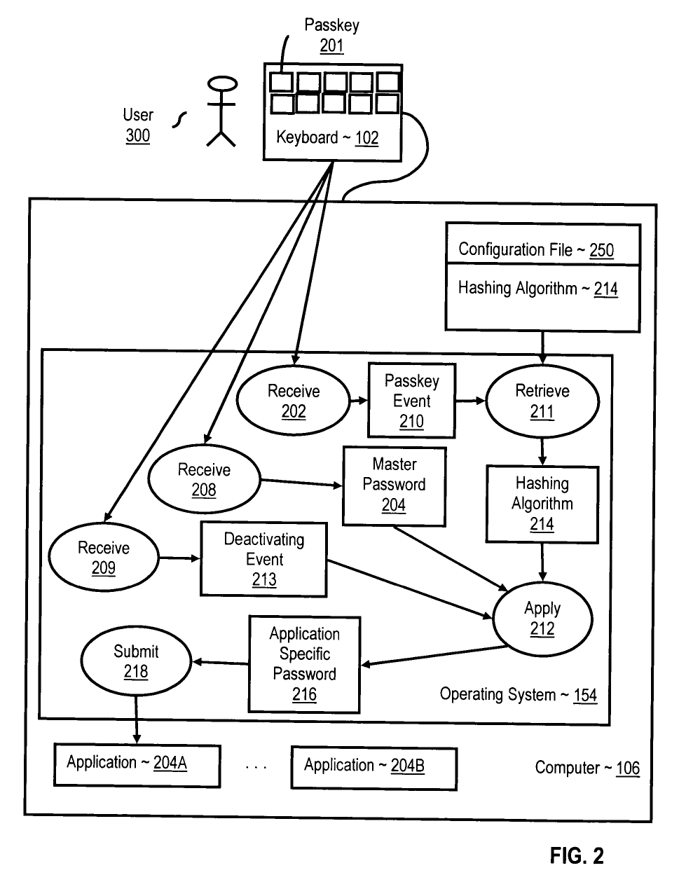

FIG. 2 is a software architecture diagram illustrating an exemplary method for providing a password to an application in accordance with the present invention. The method of FIG. 2 includes receiving 202, from a user 300, a passkey event 210 uniquely associated with one of a plurality of applications 204A, 204B requiring a password. A passkey event is an event received by an operating system that is created by a user's invoking a passkey 201. While the passkey 201 of FIG. 2 is a designated key on a keyboard, a passkey can be can be any input device such as one or more keys of a keyboard, buttons of a mouse, special hardware tokens, or any other input device that will occur to those of skill in the art.

In the method of FIG. 2, a passkey is associated with a particular password protected application 204A. To access the password protected application using the method of FIG. 2, the user depresses the passkey 201, thereby creating a passkey event received through an interface adapter an operating system 154. When the operating system receives a passkey event, instead of passing the event to a password protected application 204A, the operating system activates a passkey function. While the example of FIG. 2 describes a passkey uniquely associated with a particular password protected application, in some embodiments a single passkey is associated with more than one password protected application.

The method of FIG. 2 includes retrieving 211 a hashing algorithm 214 in dependence upon the passkey event 210. A hashing algorithm is an algorithm designed to alter the values of the characters of a particular master password to generate an application specific password. The hashing algorithm 214 associated with the passkey event 210 is typically an algorithm designed to alter the values of the characters of the same master password to generate an application specific password. Typical hashing algorithms include hash values used to alter the value of individual characters of the master password and rule algorithms designed to alter the characters of the master password such that the application specific password is compliant with the password requirements of the password protected application.

As discussed above, in the method of FIG. 2, the passkey 201 is uniquely associated with a particular password protected application 204A. Retrieving a hashing algorithm in dependence upon the passkey event therefore includes retrieving an application specific algorithm designed to generate an application specific password for the password protected application associated with the passkey event.

In the method of FIG. 2, the hashing algorithm 214 is retrieved from a user configuration file 250 stored on the computer 106. User configuration files are data structures containing information useful in algorithmically generating a password in accordance with the method of FIG. 2. Typical configuration files 250 include various application specific hashing algorithms 214 indexed by associated passkey events 210. Passkey events 210 maybe encoded for storage in configuration files as Unicode values, EBCDIC, ASCII, references to class objects, and in other ways as will occur to those of skill in the art.

The method of FIG. 2 includes receiving 208, from a user 300, a same master password 204 for access to each of the plurality of applications 204A, 204B. In many examples of the method of FIG. 2, the same master password is a single password used by a user to gain access to a plurality of password protected applications, each of which require a different password. Because the user may enter the same master password for a plurality of different applications, the password can be easy for the user to remember.

While the passkey function is active, such as when the passkey is depressed, instead of passing the events generated by a user entering the master password to the password protected application 204A, the operating system 154 receives input events as individual characters of the master password. In many examples of the method of FIG. 2, the operating system passes the individual characters of the master password to a buffer. In many examples of the method of FIG. 2, the buffer is cache memory available to the operating system to facilitate generating an application specific password.

The method of FIG. 2 includes receiving 209 a deactivating event 213. In the method of FIG. 2, the deactivating event 213 is created by releasing the passkey 201. While the deactivating event of FIG. 2 is created by releasing the passkey, in various embodiments, the deactivating event can be created by a user invoking any input device such as one or more keys of a keyboard, buttons on a mouse, special hardware tokens, or any other input device that will occur to those of skill in the art. Receiving a deactivating event is typically carried out by the operating system 154.

In dependence upon receiving the deactivating event 213, the method of FIG. 2 includes applying 212 the hashing algorithm 214 associated with the passkey event 210 to the master password 204 to generate an application specific password 216. Because the hashing algorithm can be designed to generate a strong password, applying the hashing algorithm often generates a password that is difficult to crack. In many examples of the method of FIG. 2, the user does not know the result of the algorithm and therefore does not know the actual password being generated. In fact, the user only needs to know the passkey associated with that password protected application and the same master password which may be easy for a user to remember. Furthermore, the hashing algorithm and resulting password can be periodically changed for increased security without the user ever knowing or caring what the actual password is.

The method of FIG. 2 includes submitting 218 the application specific password 216 to the application 204A for access by the user 300. Submitting the application specific password to the application for access by the user is typically carried out by the operating system. The operating system preferably passes the algorithmically generated application specific password character-by-character to the password protected application.

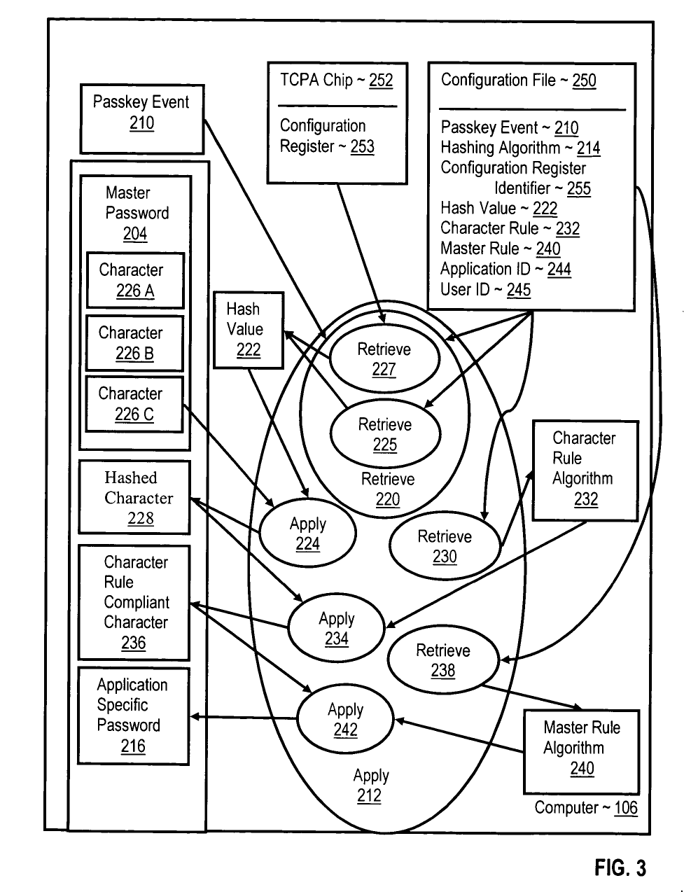

FIG. 3 is a software architecture diagram illustrating an exemplary method of applying 212 a hashing algorithm 214 associated with the passkey event 210 to the same master password 204 to generate an application specific password 216. In the method of FIG. 3, applying 212 a hashing algorithm 214 associated with the passkey event 210 to the same master password 204 to generate an application specific password 216 includes retrieving 220 a hash value 222 associated with the passkey event 210. A hash value is a value used to algorithmically alter at least one character of the master password received while the passkey function is active. The hash value is typically a value unique to the passkey event 210.

FIG. 3 illustrates two alternative ways of retrieving a hash value. On way of retrieving 220 a hash value 222 associated with the passkey event 210 illustrated in FIG. 3 includes retrieving 225 a hash value from a user's configuration file 250. In some examples of the method of FIG. 3, a user's configuration file stored on the user's computer includes a hash value 222 uniquely associated with the passkey event.

Another way of retrieving 220 a hash value 222 associated with the passkey event 210 includes retrieving 227 a hash value 222 from a configuration register 253 installed on the user's computer 106. One example of a configuration register that has a list of hash values available to the passkey function is the platform configuration register of a TCPA-compliant chip. Many computers include on-board security chips such as the TCPA-compliant chip 252 of FIG. 3. TCPA stands for the Trusted Computing Platform Alliance (TCPA). TCPA is an organization that has produced open specifications for a security chip currently available in many computers. TCPA-compliant chips are designed to provide client machines with hardware for client side security.

TCPA-compliant chips typically include a Platform Configuration Register (“PCR”). As a security measure during the boot sequence, the TCPA chip identifies particular configuration information of a computer such as specific software installed on the computer, assigns a hash value to each of the identified configuration information, crates a list of the hash values and identified configuration information, and stores the list in the PCR. The PCR is useful in some examples of the method of FIG. 3 because the PCR already has an on-board a list of hash values available to the passkey function. In many examples of the method of FIG. 3 therefore, instead of requiring a particular hash value to be predetermined and included in the user's configuration file, the configuration file includes a configuration register identifier 255 that identifies one of the list of hash values of the configuration register. The user's configuration file, rather than containing an actual hash value, need only identify which hash value on the list of hash values in the PCR to use with a particular application. Retrieving the hash value from an on-board configuration register advantageously provides increased security, because the actual hash value is not located within the user's configuration file and therefore not available to would be intruders who gain access to the user's configuration file.

In the method of FIG. 3, applying 212 a hashing algorithm 214 associated with the passkey event 210 to the same master password 204 to generate an application specific password 216 includes applying 224 the hash value 222 to at least one character 226 of the same master password 204 to generate at least one hashed character 228. In some examples, each character of the same master password is represented by a Unicode value associated with each keyboard stroke of the master password. In many examples, therefore, applying a hash value includes creating a new value by multiplying, dividing, adding, subtracting, or otherwise altering the Unicode value associated with the character of the master password with the hash value to create a hashed character value.

In the method of FIG. 3, applying 212 a hashing algorithm 214 associated with the passkey event 210 to the master password 204 to generate an application specific password 216 includes retrieving 230 a character rule algorithm 232. In many examples, each password protected application has rules concerning characters that may be used for a password. A character rule algorithm therefore, is an algorithm designed to convert the value of the hashed character to a value that is compliant with the password protected application's character rules. In the method of FIG. 3, the character rule algorithm is retrieved from a user's configuration file 250.

Although FIG. 3 illustrates retrieving only one character rule algorithm, many password protected applications have different rules for various characters of a password. For example, an application may have a rule requiring the password to begin or end with a number and requiring other characters of the password to be letters. In some examples of the method of FIG. 3 therefore, a different character rule algorithm may be retrieved to alter different characters of the master password.

In the method of FIG. 3, applying 212 a hashing algorithm 214 associated with the passkey event 210 to the master password 204 to generate an application specific password 216 includes applying 234 the character rule algorithm 228 to the hashed character 228 to generate a character rule compliant hashed character 236. In many examples of the method of FIG. 3, applying the character rule algorithm includes altering the value of the hashed character to make the value a character rule compliant value. In many examples, the character rule compliant value is a Unicode value recognized by the password protected application and compliant with password character rules of that password protected application.

Many password protected applications not only have rules for each individual character, but also have rules about the overall length, form or context of the password. For example, password protected application may not allow a password to exceed 10 characters or require that at least one of the characters be a number. In the method of FIG. 3 therefore, applying 212 a hashing algorithm 214 associated with the passkey event 210 to the master password 204 to generate an application specific password 216 includes retrieving 238 a master rule algorithm 240. A master rule algorithm is an algorithm designed to alter a plurality of character compliant hashed characters such that the plurality of character rule compliant hashed characters comply with the password requirements of the password protected application. In the method of FIG. 3, retrieving a master rule algorithm includes retrieving a master rule algorithm from a users configuration file stored on the computer.

In the method of FIG. 3, applying 212 a hashing algorithm 214 associated with the passkey event 210 to the master password 204 to generate an application specific password 216 includes applying 242 the master rule algorithm 240. In many examples, of the method of FIG. 3, applying the master rule includes applying an algorithm to a plurality of character rule compliant hashed characters to create a password that is in compliance password requirement of the application. In some examples of the method of FIG. 3, applying the master rule includes deleting one or more rule compliant hashed characters, or adding one or more characters to meet a length requirement or form requirement of the application's password.

Readers will notice that in the method of FIG. 3, the user's configuration file including the hashing algorithm, hash values, and rules used to generate an application specific password is stored on the user's computer. A user may, however, access password protected applications from more than one computer using the method of FIG. 3. To do so, the user may export the configuration file to other computers. To maintain security, it is advantageous for a user to encrypt the user's configuration file before exporting that configuration file to other computers. One way of encrypting the configuration file is by using the-board public key encryption tool provided by many TCPA compliant chips. The user can then separately send the encrypted configuration file and the public key to decrypt the configuration file to another computer.

As an aid to further understanding the method of FIG. 3, the following use case is provided. The F1 key is designated as passkey for a particular password protected application. The user depresses the F1 key creating a passkey event detected by the operating system of the user's computer and activating the passkey function. While the F1 key is depressed, the user enters a master password “bella.” The passkey function of the operating system retrieves from the user's configuration file a hash value h and a hashing algorithm including a master rule algorithm R₀, a character rule algorithm for the first character of the password R₁, a character rule algorithm for the last character of the password R₂, and a character rule algorithm R₃ for all of the other characters of the password. The hashing algorithm is:
Password=R₀(R₁(h(“b”))R₃(h(‘e’))R₃(h(“l”))R₃(h(“l”)R₂(H(“a”))

The user releases the F1 key creating a deactivating event detected by the operating system triggering the passkey function to apply the hashing algorithm and submit the password to the password protected application. In accordance with the hashing algorithm, the passkey function of the operating system applies the hash value h to each character of the master password “bella.” The passkey function then applies the character rules algorithms R₁, R₂, and R₃ to the first hashed character, last hashed character, and other hashed characters respectively thereby creating a plurality of character rule compliant hashed characters. The passkey function then applies the master rule R₀ to create a password and submits the password to the application.

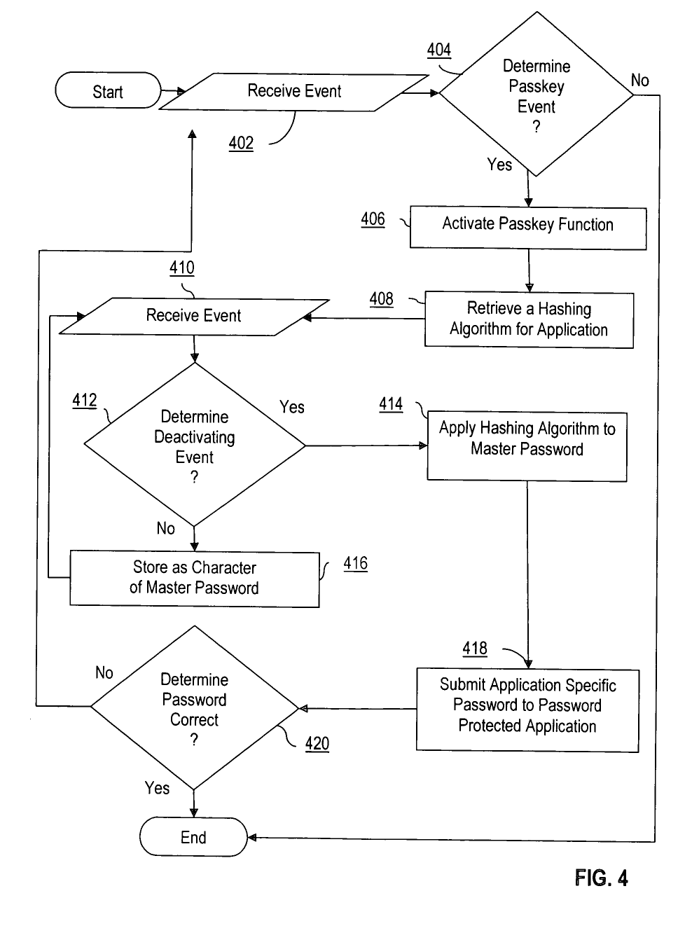

FIG. 4 is a flow chart illustrating an exemplary method for providing a password to an application in accordance with the present invention. The method of FIG. 4 includes receiving 402 an event. As discussed above, an event is typically created by a user invoking an input device such as a key or set of keys of a keyboard, a mouse, a special hardware token, or any other input mechanism that will occur to those of skill in the art.

The method of FIG. 4 includes determining 404 whether the event is a passkey event. A passkey event is an event uniquely associated with a particular password protected application and a passkey event for that activates a passkey function in the operating system.

If the event is a passkey event, the method of FIG. 4 includes activating 406 the passkey function. If the event is not a passkey event, the passkey function is not activated, and the event is passed on to an application without modification by the passkey function.

With the passkey function active, the method of FIG. 4 includes retrieving 408 a hashing algorithm. Many examples of the method of FIG. 4 include retrieving a hashing algorithm from a user's configuration file in dependence upon the passkey event. That is, an application specific hashing algorithm identified by the application specific passkey event is retrieved from the user's configuration file. Typical hashing algorithms manipulate a master password by applying hash values to characters of the master password, applying character rule algorithms to the characters of the master password, and applying master rules to a plurality of the hashed and character rule compliant characters to create an rule compliant application specific password.

With the passkey function active, the method of FIG. 4 includes receiving 410 another event. As discussed above, an event is typically created by a user invoking an input device such as a key or set of keys of a keyboard, a mouse, a special hardware token, or any other input mechanism that will occur to those of skill in the art.

The method of FIG. 4 includes determining 412 if the event is a deactivating event. A deactivating event is an event that triggers applying the hashing algorithm and submitting the application specific password to the application. One way of creating a deactivating event is releasing the passkey.

If the event is not a deactivating event, the method of FIG. 4 includes storing 416 the received event as the first character of the master password. In many examples of the method of FIG. 4, each received event is stored as the next character of the master password until a deactivating event is received.

When a deactivating event is received, the method of FIG. 4 includes applying 414 the hashing algorithm to the master password. In many examples of the method of FIG. 4, applying a hashing algorithm includes applying a hash value to each character of the master password to create a plurality of hashed characters, applying a character rule algorithm associated with password protected application to each hashed character to create a plurality of character rule compliant character, and applying a master password algorithm to generate an application specific password for the application.

Once the application specific password is generated, the method of FIG. 4 includes submitting 418 the password to the password protected application. The method of FIG. 4 includes determining 420 whether the application specific password submitted to the application is correct. If the password is correct, the user is granted access to the application.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for providing a password to an application, the method comprising:
receiving, from a user, a passkey event uniquely associated with one of a plurality of applications requiring a password;
receiving, from a user, a same master password for access to each of the plurality of applications;
applying a hashing algorithm associated with the separate input event to the master password to generate an application specific password; and
submitting the application specific password to the application for access by the user.

2. The method of claim 1 wherein applying a hashing algorithm associated with the passkey event to the same master password to generate an application specific password comprises:
retrieving a hash value associated with the passkey event; and
applying the hash value to at least one character of the same master password to generate at least one hashed character.

3. The method of claim 2 wherein retrieving a hash value associated with the passkey event comprises retrieving hash value from a user's configuration file.

4. The method of claim 2 wherein retrieving a hash value associated with the passkey event comprises retrieving a hash value from a configuration register.

5. The method of claim 2 wherein applying a hashing algorithm associated with the passkey event to the master password to generate an application specific password comprises:
retrieving a character rule algorithm; and
applying the character rule algorithm to the hashed character to generate a character rule compliant hashed character.

6. The method of claim 3 wherein applying a hashing algorithm associated with the passkey event to the master password to generate an application specific password comprises:
retrieving a master rule algorithm; and
applying the master rule algorithm.

7. The method of claim 1, wherein receiving, from a user, a passkey event uniquely associated with any given one of the plurality of applications comprises receiving, from a user, an event created by a user's engaging a keyboard key.

8. A system for providing a password to an application, the system comprising:
means for receiving, from a user, a passkey event uniquely associated with one of a plurality of applications requiring a password;
means for receiving, from a user, a same master password for access to each of the plurality of applications;
means for applying a hashing algorithm associated with the separate input event to the master password to generate an application specific password; and
means for submitting the application specific password to the application for access by the user.

9. The system of claim 8 wherein means for applying a hashing algorithm associated with the passkey event to the same master password to generate an application specific password comprises:
means for retrieving a hash value associated with the passkey event; and
means for applying the hash value to at least one character of the same master password to generate at least one hashed character.

10. The system of claim 9 wherein means for retrieving a hash value associated with the passkey event comprises means for retrieving hash value from a user's configuration file.

11. The system of claim 9 wherein means for retrieving a hash value associated with the passkey event means for comprises retrieving a hash value from a configuration register.

12. The system of claim 9 wherein means for applying a hashing algorithm associated with the passkey event to the master password to generate an application specific password comprises:
means for retrieving a character rule algorithm; and
means for applying the character rule algorithm to the hashed character to generate a character rule compliant hashed character.

13. The system of claim 10 wherein means for applying a hashing algorithm associated with the passkey event to the master password to generate an application specific password comprises:
means for retrieving a master rule algorithm; and
means for applying the master rule algorithm.

14. The system of claim 8, wherein means for receiving, from a user, a passkey event uniquely associated with any given one of the plurality of applications comprises means for receiving, from a user, an event created by a user's engaging a keyboard key.

15. A computer program product for providing a password to an application, the computer program product comprising:
a recording medium;
means, recorded on the recording medium, for receiving, from a user, a passkey event uniquely associated with one of a plurality of applications requiring a password;
means, recorded on the recording medium, for receiving, from a user, a same master password for access to each of the plurality of applications;
means, recorded on the recording medium, for applying a hashing algorithm associated with the separate input event to the master password to generate an application specific password; and
means, recorded on the recording medium, for submitting the application specific password to the application for access by the user.

16. The computer program product of claim 15 wherein means, recorded on the recording medium, for applying a hashing algorithm associated with the passkey event to the same master password to generate an application specific password comprises:
means, recorded on the recording medium, for retrieving a hash value associated with the passkey event; and
means, recorded on the recording medium, for applying the hash value to at least one character of the same master password to generate at least one hashed character.

17. The computer program product of claim 16 wherein means, recorded on the recording medium, for retrieving a hash value associated with the passkey event comprises means, recorded on the recording medium, for retrieving hash value from a user's configuration file.

18. The computer program product of claim 16 wherein means, recorded on the recording medium, for retrieving a hash value associated with the passkey event means, recorded on the recording medium, for comprises retrieving a hash value from a configuration register.

19. The computer program product of claim 16 wherein means, recorded on the recording medium, for applying a hashing algorithm associated with the passkey event to the master password to generate an application specific password comprises:
means, recorded on the recording medium, for retrieving a character rule algorithm; and
means, recorded on the recording medium, for applying the character rule algorithm to the hashed character to generate a character rule compliant hashed character.

20. The computer program product of claim 17 wherein means, recorded on the recording medium, for applying a hashing algorithm associated with the passkey event to the master password to generate an application specific password comprises:
means, recorded on the recording medium, for retrieving a master rule algorithm; and
means, recorded on the recording medium, for applying the master rule algorithm.
